(19) United States
(12) Patent Application Publication
(10) Pub. No.: US 2004/0004337 A1
(43) Pub. Date: Jan. 8, 2004

(54) Spring shackle mounted anti-roll device and frame stiffener

(76) Inventor: M. Chad Harshbarger, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/190,855

(22) Filed: Jul. 8, 2002

(51) Int. Cl. B60G 9/04

(52) U.S. Cl. 280/124.107

(57) ABSTRACT

A suspension system for the steering axle of a vehicle chassis provides anti-roll and frame stiffening properties. First and second leaf springs are provided aligned with longitudinal frame rails for a vehicle. An axle is attached to the middle portion of each of the first and second leaf springs with the axle being aligned transversely to the longitudinal frame rails. First and second shackle boxes depend from the longitudinal chassis frame rails aft of the axle and substantially adjacent the area of the longitudinal frame rails upon which the cab is supported. One end of each of the first and second leaf springs depends from one of the first and second shackle boxes. A bar is mounted transversely to the pair of longitudinal frame rails, connected between the first and second shackle boxes to resist vehicle roll and to stiffen the frame.

### BACKGROUND OF THE INVENTION

1. Field of the Invention

The present invention relates to vehicle suspension systems and, more particularly, to an anti-sway device which also provides frame stiffening.

2. Description of the Problem

Truck suspension systems are designed to meet each of several not wholly compatible goals which include: absorbing road shock; providing a comfortable ride; stabilizing the vehicle, especially against sway during cornering; and maintaining proper axle spacing and alignment, which also helps to keep the vehicle under control and to extend tire life. Vehicle sway or roll can be countered by stiffening springs, however, high spring rates contribute to a stiff and uncomfortable ride. Still, most truck manufacturers use high enough spring rates to substantially control roll. Some designs have added wide spring centers, asymmetrical springs and auxiliary springs which in effect provide a variable spring rate as a function of spring deflection. Instead of stiffening springs, anti-sway bars may also be installed, however most prior art designs for anti-sway bars have proven expensive and difficult to package.

A good ride also depends upon a high degree of frame stiffness in the cab mounting area. Various types of cross and x-members can be used to achieve frame stiffness. However, cross members have typically been expensive to install under the cab due to the engine, transmission and drive train in the same area or nearby. To provide additional frame stiffness in the cab area many trucks have been provided with a bellyband member. This cross member type is typically mounted in the area of the front cab mounts and wraps under the truck's transmission.

The assignee of the present patent marketed the International Scout from the 1960's to the early to 1980's. Most models of this vehicle were equipped with front leaf spring suspensions which were attached to the front of the vehicle using shackle boxes. In some models, an anti-sway bar was constructed of rectangular bar stock mounted between the shackle boxes, ahead of the axle at the front of the vehicle. While this suspension was similar in construction to the prior invention, its geometry was reversed, having the effect that the anti-sway bar did not contribute to frame stiffness under the cab.

### SUMMARY OF THE INVENTION

It is an object of the invention to provide a spring suspension system characterized by improved resistance to roll.

It is another object of the invention to improve frame stiffness.

The foregoing objects are achieved as is now described. The invention provides an anti-roll suspension system for the steering axle of a truck and a frame stiffening system. The longitudinal frame rails of the truck support a cab. First and second leaf springs are provided aligned with the longitudinal frame rails. An axle is attached to the middle portion of each of the first and second leaf springs with the axle being aligned transversely to the longitudinal frame rails. First and second shackle boxes depend from the longitudinal chassis frame rails aft of the axle and substantially adjacent the area of the longitudinal frame rails upon which the cab is supported. One end of each of the first and second leaf springs depends from one of the first and second shackle boxes. A bar is mounted transversely to the pair of longitudinal frame rails, connected between the first and second shackle boxes to resist vehicle roll and to stiffen the frame. The bar is preferably a straight member which, being below the frame, runs under the vehicle engine and transmission. Under some circumstances the member may be bent to accommodate engine or transmission packaging.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a side elevation of a truck equipped with a front leaf spring suspension;

FIG. 2 is a perspective view in partial phantom illustrating the location of the frame stiffening and anti-roll member of the invention; and

FIG. 3 is a perspective view of the improved suspension system.

### DETAILED DESCRIPTION OF THE INVENTION

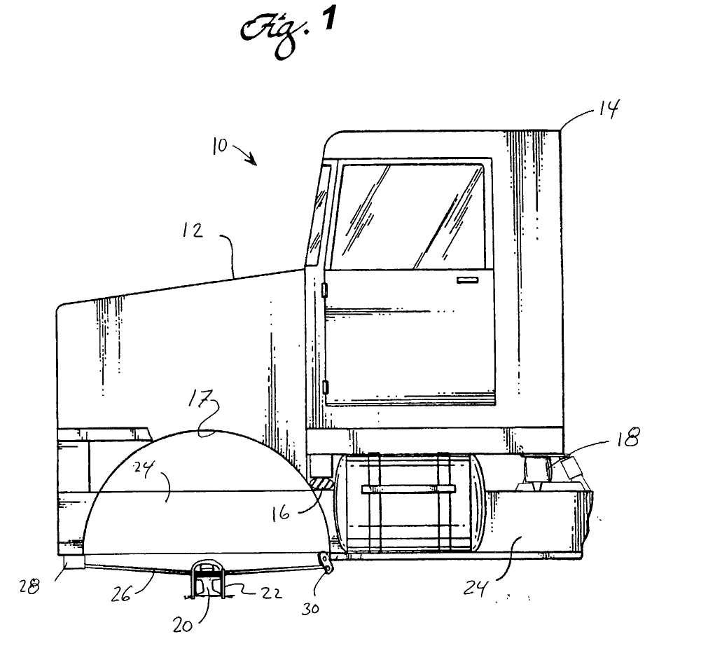

Referring now to the figures, FIG. 1 depicts a truck 10 having a forward section 12 and a cab 14. Cab 14 is supported from a pair of longitudinal frame rails running along opposite sides of the truck. Cab 14 rests on a forward mount 16 and an aft mount 18, the specific details of which are unimportant to an understanding of the invention. A driver side frame rail 24 is visible in a driver's side forward wheel well 17. The frame rails, including driver's side frame rail 24, are supported from axles below the vehicle by springs attached between the axles and the frame rails. Visible in wheel well 17 is a front steering axle 20, which is attached to a front leaf spring 26 by a conventional U-bolt assembly 22. Leaf spring assembly 26 is connected to frame rail 24 at the front end of the vehicle by a hanger bracket 28 and to point on the frame rail below front mount 16 by a swinging shackle box 30.

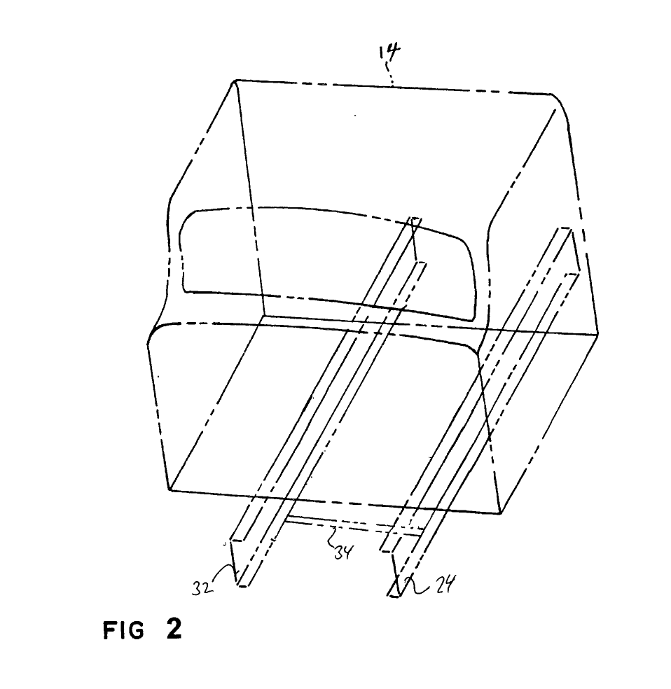

Referring now to FIG. 2, the location of a transverse member 34 is illustrated. Transverse member 34 serves as an anti-sway bar and frame stiffening element. Transverse member 34 is located under the front portion of cab 14 and is intended to stiffen the frame comprising longitudinally extending frame rails 24 and 32 in the front area of the cab. Transverse member 34 is also located longitudinally along the frame with the shackle boxes to serve as an anti-sway or roll bar. It is mounted between and connected to the shackle boxes as illustrated below to provide the anti-sway function.

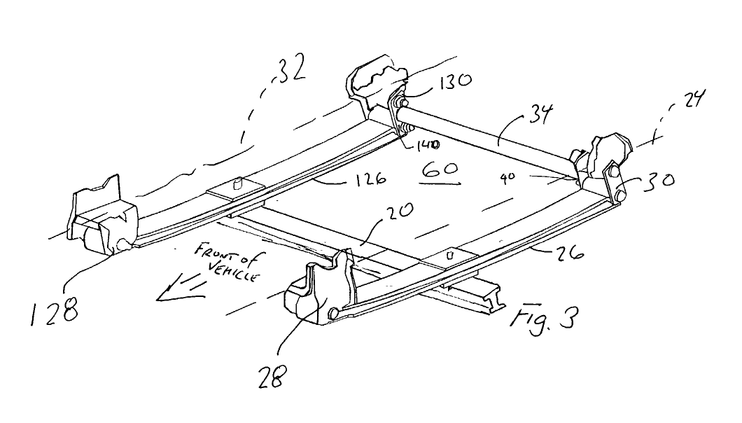

FIG. 3 illustrates the inventive suspension system 60 comprising first and second leaf springs 26 and 126 located longitudinally aligned on frame rails 24 and 32, respectively. Leaf springs 26 and 126 are illustrated as being double leaf, however the invention is applicable to other leaf spring configurations. Axle 20 is located under springs 26 and 126, and is attached to leaf springs 28 and 128 at approximately the midpoint of the leaf springs between the attachment points of the leaf springs to the frame rails. Leaf spring 26 is connected to frame rail 24 at the front end of the vehicle by a hanger 28. The rear end of spring 26 is connected to frame rail 24 by a swinging shackle box 30. Leaf spring 126 is connected to frame rail 32 at the front end of the vehicle by a hanger 128. The rear end of spring 126 is connected to frame rail 32 by a swinging shackle box 130. Positioned transversely with respect to the frame rails 24 and 32 and extending between and connected to shackle boxes 30 and 130 is transverse structural member 34. Transverse structural member 34 is preferably a tube, but may have other cross sectional shapes, for example square or it may be rectangular bar stock. Opposite ends of member 34 are conventionally connected to the relatively inside brackets 40 and 140 of shackle boxes 30 and 130. While welding is preferred, other methods of attachment may be used in other applications. Because shackle boxes 30 and 130 are not allowed to swing freely of each other, member 34 performs an anti-roll function. Local twisting to the frame of the vehicle tends to be coupled to the shackle boxes, with the result that the member 34 functions as a frame cross-member, stiffening the frame.

The invention provides a leaf spring suspension system with improved vehicle stability characterized by increased resistance to roll and improved frame stiffness. These advantageous properties are achieved without the need to stiffen excessively the front leaf springs, and further provide for the potential elimination of a frame belly band member.

While the invention is shown in only one of its forms, it is not thus limited but is susceptible to various changes and modifications without departing from the spirit and scope of the invention.

What is claimed is:

1. A vehicle comprising:
first and second chassis frame rails arranged longitudinally on opposed sides of the vehicle;
a cab mounted across the frame rails;
first and second leaf springs arranged aligned on the first and second chassis frame rails, respectively;
an axle attached generally to middle sections of the first and second leaf springs, the axle being aligned transversely to the first and second chassis frame rails;
first and second shackle boxes depending from the first and second chassis frame rails aft of the axle and adjacent the area from which the cab is mounted, the first and second shackle boxes supporting one end each of the first and second leaf springs from the first and second chassis frame rails; and
a bar mounted between the first and second shackle boxes.

2. A suspension and frame stiffening system for a vehicle having a pair of longitudinal frame rails and a cab supported from the frame rails, the suspension and frame stiffening system comprising:
first and second leaf springs positioned aligned with respect to and under the longitudinal frame rails;
an axle attached generally to middle sections of the first and second leaf springs, the axle being aligned transversely with respect to the longitudinal frame rails;
first and second shackle boxes depending from the longitudinal chassis frame rails aft of the axle and substantially adjacent an area of the longitudinal frame rails from which the cab is supported, the first and second shackle boxes supporting one end each of the first and second leaf springs from the first and second chassis frame rails; and
a bar mounted transversely to the pair of longitudinal frame rails between the first and second shackle boxes.

3. The suspension and frame stiffening system as set forth in claim 2, wherein the bar is a straight member.

4. A stabilizing system for a vehicle having a frame and a suspension system including springs aligned with opposing sides of the vehicle and an axle, the stabilizing system comprising:
hinged suspension members connected between the springs and the frame on opposing sides of the vehicle aft of the axle; and
a link between the hinged suspension members.

5. A stabilizing system as set forth in claim 4, wherein the hinged suspension members are shackle boxes.

6. A stabilizing system as set forth in claim 5, wherein the link is a bar.
